(19) United States
(12) Patent Application Publication
(10) Pub. No.: US 2025/0075687 A1
(43) Pub. Date: Mar. 6, 2025

(54) Time machines 5.

(71) Applicant: Menni Menashe Zinger, Ashkelon (IL)

(72) Inventor: Menni Menashe Zinger, Ashkelon (IL)

(21) Appl. No.: 18/241,930

(22) Filed: Sep. 4, 2023

(51) Int. Cl. F03G 7/10; H02K 53/00

(52) U.S. Cl. CPC F03G 7/135; H02K 53/00

(57) ABSTRACT

People always dreamed to travel at time to the past and/or future at this invention I show ways to do that.

Hello. At same day today I got two letters about this application Ser. No. 17/080,105,one is about petition is granted to me and the other letter is about rejection of claims 1-22 from 1-22 pending claims at this invention and about a draw that is hand writing because the invention is very sensitive and secret from some point of view. also at a phone call with uspto representative last week it was told to me that this application was revived and would be published at May 1, 2023 at your website after it was suppose to be published year before at April 2022. I also got a letter about this publication from the uspto.

The specification is claim 1 of this application.

There is no need to break the speed of light with using great spaceship but I suggested magnetic and/or electro magnetic/t.v. waves, frequencies/radio waves frequencies which move at the speed of light and magnetic waves are even a lot faster than the speed of light, more than 200 times faster and also pneumatic method with a model of different places combining the other methods here and the passenger and/or shipment/object/s would be launched at no time, zero time or very close to zero time from one point to an other at time and/or place and would crystalize/thickens after they were diluted into almost zero, zero at certain moment and at no time they are pulled by magnetic/electro magnetic etc. other forces written above into the destiny point at the wanted time and place after pulling them by those forces and from 100% into 0% or close into 100% again at destiny from exit point at no time, zero time and exact frequencies would be in use of magnetic/electro magnetic etc. forces in order to aim/lock better on passenger and/or object/s shipment/s by scanning them/it by using frequency scanner that is able to observe the frequency of different objects and people using also sim card with different number/identification and lock on it or even sim card adjusted to shipment/object launched and the dilution would be done by using static electric or frequencies that might do so and or by inspiring on launched people/objects air or vacuum at right strength.

Even so other physic experts did not believe at quantum mechanics and possible breaking of speed of light I claim I have new theory and invention that I show above here that might work and be able to send people and or objects to other time at past and/or future and return them back to same point after mission at very short time using above methods and invention and about speed of light, magnetic waves can be faster the speed of light more than 200 times. this invention with great novelty so there are no or few support at former documents but since fiction movies and books, other but I believe I am claiming a true invention that can work right and create revulsion on science/physics.

About the paradox of a passenger at time that will kill his grand father, so, he will appear with new grandfather and father somehow the same or the operation will be void at the moment the killing of the grandfather will be done let say 50 years at the past or the passenger would not even be born but nevertheless it is not preventing from time machine to work but it is esoteric case that might happen but not technological block.

The attraction/pull of a passenger and/or object/shipment to other time/scenario/dimension/universe/planet/moon is still possible by using magnetic/electro magnetic powers/frequencies/waves, accurate, using sim card/mobile phone/smartphone and its number and also using cells of launching is possible and special clothes and wearing, helmet, shoes and or pneumatic pipes/tunnels between different government or civilian buildings including transportation between cities/countries/planets/moons/inside city between stations. It is probably to much to ask to build a working time machine from a regular civilian as me, specially at my conditions when I am being persecuted because of my invention at Israel and without be able to raze money to build the time machine.

tel: 0522274294

menniz@012.net.il

Maybe god that created the world by the holly bible, genesis chapter 1, holly sentence 1 got a lot weaker days after he was created himself by forces of physics and become first Adam, first man, and his size become 100 meters instead of endless meters not because god put hid palm over him and minimize him but because god himself become first Adam, first man because he lost a lot of powers because that was the natural course of forces of physics that he could not stop and change direction, his destiny into mortality also because the world was created and matter too and the matter made him un pure and weaken him in front of no matter before that existed. god was created because of physics forces and the universe is being created by itself by those forces again and again in no time and not billions of years as I wrote also at my invention number 279390.il2020. 287097.il2021, at description and there is movement of weather vane between existing universe into collapse of universe and in no time a new universe from the beginning. “before him no god was created”, there is holly sentence like that at an holly song. and god is being created again and again too maybe .parallel to god other force was created, the other side, the satan, and angels maybe because of other, opposite electro magnetic/magnetic/electric field forces and the satan survived better and is stronger and persecutes god that become a human been/person, the wright rest, the messiah, the prophet every generation and the satan prevent the messiah from getting stronger in order to keep his power and control and it can be seen that there is no justice at a lot of cases, “wright rest and its bad to him and evil person has good life” by the Tora opinion itself and the believers waits that the messiach will get stronger and stronger until the Geula, the revelation will happen as it written at Daniel book at the holly bible at a prophecy called the stone of Daniel that become bigger and bigger after it dis apart from the statue from the dream of the Babylonia king Nevuchadnazer and break the feet of the statue and eventually become so big that its fill the all world and that represent the messiah.

the Angele, at list some of them tried to help god and the satan by the holly books killed them “he razed his little finger and burn them”, angels who wanted that there would not be first Adam, for my opinion they tried to keep him as a god. also it is written that the angles went up and down and asked where is god, at heaven or is it first Adam.

1. Using quantum mechanics and inspiration zones and a model of reality, at software and/or mechanics, when the inspiration zones being created by using magnetic/electromagnetic/t.v./radio waves/electric field by inspiring with using those powers on other area from original area at different volumes and passing between the areas by diluting the people and/or objects from 100% into 0% and attracting them, sucking them into other inspiration area and crystalizing them from 0% into 100%. the magnetic/electromagnetic forces and all other forces written here will use different frequencies also opposite in order to have the necessary affect, that is needed to the operator use. using those methods should pass people and objects from one are, the launching point into the inspired area the destiny at zero time, even from one country to the other let say from Tel—Aviv to New-York. using those methods should even pass people and objects from one planet to other planet or moon at zero time. using those methods can pass people and objects even to other time, past or future, scenario/dimensions/universes, galaxies if exist and known to be exist. Also combinations between the destinies written. Using model of reality that has a increased dragging force on map of earth for example and/or galaxy that will allow to move between points by locating the right figure on the destiny and the increased dragging force/objection to movement will let to do so. also using at every fixed destiny a special phone code/number that will help to move the people behind the figures into the destinies. there will be attraction to the marked point by electromagnetic suction direction. the fixed points of destinies will be Using technologies written above at claims 4,5 in order launch people any were at any time to any time, place, scenario, dimension etc. even worlds, planets, moons, galaxies etc. the time needed 0 seconds or 1 second. it can pull people and/or equipment to inspiration zones at other dimension at past and or future if there is net connected or place waiting with inspiration zones. for example from today to waiting place that we created last year if we started than to next year at certain day or 20, 30 years or 100 years etc. also to the past if we transfer the knowledge 20 years backwards to the position of earth at last year or 20 years ago at space on the face of it exactly by inspiration zone 1:1 to that point on the model I wrote at claim 6 here. We can do that a lot of times let say 20 jumps for example and travel 400 years or more. We need astronomic calculations that exists accurately. also we can use what I wrote here at claim 4 for example or 5 or both, to go 1 month every time or a lot more and pass the knowledge and build it then and gain 100 years for example. If the information would not be kept secretly all history will look different beyond time a lot more than special uses. Using a cell with oval shape or other maybe square with inspiration 1 and weaken it to 0 and pulling the people and or equipment to inspiration zones that will increase power from 1 or 0 to 2, 5, 10 and the there will be transfer of people and/or equipment to the inspiration zone than stabilizing it at 1 g or other unit default base position. there is a chance also by logic that 1:1 is needed. maybe no cell is needed only room or open place at field. It can be used by special buildings, structures, central train, bus transportation, places. air ports, harbors etc. using different shapes in order to represent different worlds, states areas and or different states of dilution and work very fast and easy. using agreed symbols. passing the passenger figure on screen to other symbol will pass it to other galaxy, universe, planet etc. other screen can also represent other far place on net of computers. using ultra sound and x ray in order to dilute objects and people also using static electric in order to dilute and opposite by other currency and or minus and plus connections also brushing can cause static electric effect and certain material like cleaning material and terpentin, tiner maybe. Maybe static electric dilution can be done beyond time by interfering at electric field used for time travel, dimension travel. Also Using the model and increased gravity in it and placing a figure like chess figure on other place end other planet, moon etc also at other time dimensions, scenarios combined all this options. increased or 1:1, or 0 and between with different power levels. gravity with magnets, radio, television waves, electric field, electric current etc. all combinations.
Also Using figures at software and moving them on screen also increased power maybe needed, and drugging figures from time to time maybe screen to screen, dimensions, scenarios, worlds etc. also on based on claims 5,11. Using also mice and keyboard and operation stick. including driving spaceships, plains, vehicles of all kinds, people, planets, galaxies all universe maybe as figure and it will move all material 1 billion kilometers to the east that we choose to be east or west etc. also driving them at time including galaxies and planets. all universe can be move at time dimension or be doubled, multiplied. also minimized or bigger, using the increased power at inspiration zones, quantum mechanics, and model/software if needed.
Also Using gravity particles and time particles, term I entered to lexicon and gravity waves in order to move at time and dimensions, also multiply them by inspiration zones from can be 10 or more, and all equipment, material, people can be multiplied 1:1 or all other ratio needed. including gold, diamonds, metal, food, water particles off all kinds, gas fields, oil, fuel, also increased, tanks full of them, plains.
using quantum mechanics and inspiration zones and serial of models at software and/or mechanics representing different times and even different scenarios/dimensions, combined at one room observed and monitored and able to find a certain smartphone user/device at different times let say every day at 1600 p.m. and able to do operations at comfortable way and doing changes as needed for security reasons or other very important legal reasons by using also line of screens showing different scenarios/times/dimensions and/or split screen/s. also able to focus/zooming on the map/model at software. hyperlink or active x points as possibility. good method to diluted is to use static electric also. Using spaceships that I invented at invention number 262189 il.2018. in order to move multiply times of speed of voice, for example 10 times the speed of voice at air, metal, water etc. or 100 times more fast. tests needed and Using spaceships I invented at invention 262189 il.2018. in order to move faster than the speed of light, and by that move at time, and scenario, dimensions by changing angle at slight difference and/or more than few degrees. the maneuver should be at middle way by program that will start at very small change of angle. minimum, prequel of angle. Also by using frequencies that will cause slight change at angle of movement. radio, television, magnetic influence, inspiration of all of them all own or all possible combinations, electric field, electric currents. or other frequencies. There will be ratio of 1:1, 1:1000, 1:1 million, 1:1b, 1:1t, 1:1td, 1:1q,: 1kq, 1qq etc. at inspiration zones in order to gain great power.
using quantum mechanics and inspiration zones and possibly the model computerized with software and/or mechanics in order to launch people outside the minimized universe their in to by placing a stick with smartphone number duplicated of the passenger at wanted point even at next model of other earth or other planet or other country, city etc. or other point at earth outside an hidden minimized territory. the barcode will have the same phone number and the passenger would be aimed to his duplicated smartphone/stick with number or to duplicated smartphone placed by other person who helps him abroad or at other universe, other earth/planet/moon and waiting near the duplicated smartphone in order to secure it until the passenger at time and scenario/dimension/universe will arrive. also hyperlink at software at wanted point or active x in order to represent the phone mobile number/smartphone or other objects/people.
invention and theory at physics: using quantum mechanics and inspiration zones and the model, at software and/or mechanics in order to pass from one side of the universe to the opposite side by moving a tool from starting point to one edge of the universe and from there it would jump to the opposite side because for my theory it would be suction to the opposite magnetic poll side of the universe. and the opposite is possible too by moving from the new side to the near edge and from there the space sheep will get to the first edge point and from there to any point by locating the right tool that represent the space sheep to any point chosen. Also adjusting the right frequency of magnetic/electromagnetic/electric field/radio/t.v waves will cause a space sheep to jump to the opposite point at galaxy, universe. using smartphone, cellular, mobile phone in order to pass a person, object after diluting it, him by using phone call to destiny that will collect it and change him, it to original shape, state or improved by needed by the receiving device or operator that will back up him, it. the dive might need projector of some kind and dilution device in order to pass between states. also using email, sms, whats up etc in order to pass person, object.

51. using plates and or vehicles just for convenience and fun in order to launch 100,1000, or more people to other country, continent, city to other central bus, train station air port, harbor also ships by using quantum mechanics and inspiration zones and diluting to zero and same time to 1 at the destiny by magnetic forces, electromagnetic forces, electric fields, radio/television waves and other methods also. all the process until flight and after can be kept but 11 hours of flying between tel aviv to new York will be saved. all that also beyond time so for example the plain can get to new York from tel aviv day before, weak before and return to same point and exit day and by that we spent 1 weak at new York and did not loose time and effort. it can be 100 years before or after also etc. also space ships can travel to other galaxy 10 years ago for a mounts or years and explore and return back at one second. zero time. also to other dimensions, scenarios by tracking the object like space sheep, people by magnetic forces, electromagnetic forces, electric fields, radio/television waves and other methods. also combinations between beyond time and beyond dimensions, universes, etc.

52. a spin of object around itself strengthen it gravity and stability at its course around sun and or galaxy and or planet. also right for gravity particles suggested exist strengthen the material there are part of and also the spin of electrons and neutrons around proton strengthen the atoms, the matter they are building, they are part of.

53. using quantum mechanics and inspiration zones in order duplicate air ports, harbors, etc. central bus, train stations etc. near existing ones or 10-50 kilometers far as needed even 300 kilometers away or more. they can be minimized and/or hidden ones. in order to save expensive place, ground. and costs of buildings. also duplicating all equipment like plains, busses, trains railroads etc.

54. using quantum mechanics and inspiration zones in order to make enemy tunnels collapse like tunnels of terrorists near borders by using magnetic, electromagnetic forces, electric fields, radio/television waves etc. By putting high weight on them, on top of tunnels and or filling them at model we prepared with connections. also beyond time if something already happened like terrorist attack.

55. using quantum and inspiration zones in order in order to launch an elevator to right floor and from there to the next one. it will disappear at ground floor for example and appear at 50th floor immediately
using quantum mechanics and inspiration in order to transfer enemy fire and or our fire towards the bases of the enemy and their filed forces by using shortcut/detonator at inspiration zone with great inspiration on the enemy bases so when the inspiration zones in front of enemy fire got hurt, the enemy bases got hurt multiply 1000 or a lot more or 1:1. also building protecting layer with strong inspiration zones in front enemy fire.

56. Using magnetic influence opposite of the poll at the area you in in order to cause rain at areas which need rain the magnetic influence will be created by using canon which created luminum/beam/ray of magnetic waves towards the sky at angels that should be tested and exact n power need to be tested too. It could be done from a plain and/or satellite also. It can be done at summer and or winter poll, spring.

57. using magnetic power and/or pneumatic power and/or vacuum tunnels for elevators in order to have very fast elevators at buildings and/or bunkers, the magnetic power will act at sides and down and/or up sides in order to tract the elevator to the wanted direction also running magnet, separate from elevator down and up and using it by need up for up and down for down when the extra magnets running on pipes and possible use of several magnets like that in order to have closer magnet to bottom of elevator and its top. at pneumatic the stopping can be by using springs and/or hydraulic mechanism and/or magnets. also adding the elevators beyond time to bunkers and/or buildings.

58. using quantum and inspiration zones in order in order to launch an elevator to right floor and from there to the next one. it will disappear at ground floor for example and appear at 50th floor immediately

59. using quantum mechanics and inspiration in order to transfer enemy fire and or our fire towards the bases of the enemy and their filed forces by using shortcut/detonator at inspiration zone with great inspiration on the enemy bases so when the inspiration zones infront of enemy fire got hurt, the enemy bases got hurt multiply 1000 or a lot more or 1:1. also building protecting layer with strong inspiration zones in front enemy fire.
using quantum mechanics and inspiration zones and a model, mechanic and/or at software with drugging force increased on screen and at the model sucking liquid, water from it that are connected to flud water at the city of Venezia nand/or after zunamy for example and by that lowering the water level to zero. also beyond time at first day, first hour and preventing the flud at city by lowering the level of water day before, weak before. also as I wrote here before lowering the oceans level and preventing floods of coasts cities all over world.
using quantum mechanics and inspiration zones and a model, mechanic and/or at software with drugging force increased on screen and at the model sucking liquid, water from it that are connected to flud water at the city of Venezia nand/or after zunamy for example and by that lowering the water level to zero. also beyond time at first day, first hour and preventing the flud at city by lowering the level of water day before, weak before. also as I wrote here before lowering the oceans level and preventing fluds of coasts cities all over world. at microcosmos like can be createeed at using quantum mechanics and inspiration zones the distance that a beam of light will pass at one second for example can be 1 meter and it will look and feel like 300000 kilometers from the point of view of people at that microcosmos, universe because the size of a people is milimetric and everything is relative also between sizes so houndreds of thousends of kilometers are equal to very few distance like one meter and person that will pass from the 1:1 world into very small scale world would not notice the difference also infront of other fenomonas like speed of sounds, radiations speeds, a question by itself I thouth about, what are the speeds of different radiations etc. if those assumption are wrong so the speed of light at microcosmos is a lot faster than 300000 kilometers for one second relatavely and also the speed of sounds voices and it would be noticed by reserchers at least if not ordinary people and also relatevaly the speed of light would be as I wrote a lot faster and it shoul go beyond time to the future and or past and not to the destiny of oser like some one who pointed with flash light and the beam would light infront of him the day after or before. and if someone woud shout he should be herd almost immediately a lot of kilometers away or at least at a distance of 340 meters, the speed of voice at air at one second without delay of one second but micro second only for example 1billion: 1 faster, reletavely, the time the sout would cross the 340 meters.
using quantum mechanics and inspiration zones between different times in order to have connection between for example 2019 and 1989 and in the future 2049 by inspiring the present on past and future at same location and/or other locations. for any use civilian and other. talking regular to each other at other time and/or location and/or by using radio/t.v. phone, smartphone, mobile phone connection between different areas. also different sscenarios and dimentions and time and dimentions combined can be connected online and/or by need. mainly to critical points/times and/or using at second step other communications at the destiny. Also inspiring directly to communications divices at different times, dimentions, scenarios combined.
using quantum mechanics and inspiration zones between different times in order to have connection between for example 2019 and 1989 and in the future 2049 by inspiring the present on past and future at same location and/or other locations. for any use civilian and other. talking regular to each other at other time and/or location and/or by using radio/t.v. phone, smartphone, mobile phone connection between different areas. also different sscenarios and dimentions and time and dimentions combined can be connected online and/or by need. mainly to critical points/times and/or using at second step other communications at the destiny. Also inspiring directly to communications divices at different times, dimentions, scenarios combined.
using quantum mechanics and inspiration zones and the model, mechanic and/or at software on screen with increased dragging force, objection in order to take liquid, water from the model with using injector like for shoots and pulling up the internal part and by that collecting water and lowering the water level at city with flud in it like at Venezia sometimes by connecting the water and or liquid with magnetic caricature at the model to the flud water with inspiration between the two water, also watching the marks on the injector in order to be accurate, for example every 10 cc represents 1 meter of flud level and if 10 meters needed to be taken away so 100 cc should be taken away at the model. also beyond time at the beginning f flud or befor in order to lower the sea level also ar all earth with that method because of rizing sea water level. using quantum mechanics and inspiration zones and the model mechanic and or at software on screen with increased dragging force, objection in order to empty volcanos from burning ashes that might be go out very fast and cover cities before eruption with using information from time macines from this invention at right moment with using injector and also from the seround of the mountain, volcano if it to late somehow, less preferred also with using injectors as soon as possible.

60. using strong electric filed and/or magnetic filed, electromagnetic influence, great t.v./radio antenna filed in order to createee corridor to other time zones, other dimentions, scenarios, other places even planets, universses etc. combined also.

61. using diluating of objects and or people below zero into anti metter in order to pass them beyond time because time depends on metter and by logic that if we be diluated the time will pass slower and the opposite if we will be thicker than 100% the time will go faster and we will get old faster so if something is antimatter, diluates below zero it automaticaly go back on time, maybe very far away even to the beginning of tome and createeion of the universe. Also the tohu vavohu is made of anti metter and createeion is passing to metter at once and so on there is cycle of createeion and distruction of the universe. on the holy Hebrew books it is wrriten: “createeing worlds and destroying them ”.

62. using space sheep flying on space and on atmosphere at speed of 1000 kilometers an hour or more even less and projecting with using lasers or beam of light an hyulic people that were diluated just before or before and/or objects inside capsule and/or wearing special space suits on face of other planet or moon or earth itself also projecting duplicates of diluated, hyulic people, the exra fast beyond the speed of light will enable time travel, x for speed of light +1000 or 10000 kilometers an hour kilometers an hour so the beam of laser/light is faster than the speed of light and might pass on time and dimentions, scenarios with aiming at an angle of some kind or directly. the hyulic people/objects can pas inside the lazer canon true screen as I wrote et this invention before and be some kind of emunition, passenger. aiming towards the destiny on surface and/or on board of sheep, space sheep.

63. using quantum mechanics and inspiration zones in order to diluate objects/people below zero and making them anti metter, anti material and the opposite way. also in order to diluate to any level for example 1:1000, 1:100000 etc. also beyond time.

64. if the universe will become anti metter from some resone and destruct it will come back at no time to same point because when there is no metter there is no meaning for time and even it can be createeed again before the last existence of it billion years before for example maybe by other level of time count and the reshimo will stretch it to the same point at present with same people at same situations and places maybe with weaker reshimo than before at total. it is possible that it would not become weaker because the anti metter stage will regenerate its power of life and existence. maybe even stronger.

65. using quantum mechanics and inspiration zones in order to inspire climate, weather, daylight, darkness by comfortable on other area, other planet, moon etc. the power and levels can be changed by comfort. multy zones inspiration also possible with different conditions. also from one planet to an other, other planet to other moon etc.

66. theory also inventions: the dark material, matter at the universe is in the black holes that has endless mass and gravity without limits almost and captures and band all lights around it at great radius, with its gravity that connect to its mass and has direct corelation between them also at planets and stars, suns. The dark metter made of gravity particals. It my assumption that there are particlesof that kind and they are couse of gravity and has duty same as balance weigth and containment for metter and between. The dark metter probably dose not exist every single point at the space but has clusterels.
Sound waves can pass better and faster true less diluated material than thinner material, for example faster true water than true air and even faster true metal with using vibrations but the voices true heavy material like metal would not be clear and understntable. and the gravity particalas probably pass the sounds, voices. so as much as the material is heavier, has greater mass, more specific weight it pass sound faster but unclearly sounds. maybve if at ears we would have more gravity particleswe would hear better and maybe sea createeures has more gravity particleson their ears and that's why they can hear better under water. the sounds cannot be sound at space because the gravity particlesare not at every point but at clusterels and it need that they would be at 100% of the space for that. Need consecutiveness, continuousness.
There is possibility that pat scan or some kind of radiation can paint the gravity particlesand mark them for example pat scan m.r.i. or sun light radiation, concentrated.
There is possibily that there are alsao time particlesthat gives a material its caricature its possibility to be moved at time easely or with more difficulty. Maybe they give time its meaning and existence and all the atom got influances from time passing because the time particlesit contains like telomers at cells. is it is possible to multiply those time particles at atoms the material would be like new one and it is possible by multiply them with using quantum mechanics and inspiration zones. maybe it need to less the number of time particlesat an atom and like that it would not be influancesd from time passing so it is the opposite than telomers at cells. maybe reshimo of events happened beyond time because of time machines are kept and pass beyond time true the time particlesdepends how strong effect the event has so it will go farer. maybe time particleseffect also our ability sence, to know are place on time. maybe if we add or less time particlesit is possible to cure senile people with Alzheimer etc.

67. at microcosmos like can be createeed at using quantum mechanics and inspiration zones the distance that a beam of light will pass at one second for example can be 1 meter and it will look and feel like 300000 kilometers from the point of view of people at that microcosmos, universe because the size of a people is milimetric and everything is relative also between sizes so houndreds of thousends of kilometers are equal to very few distance like one meter and person that will pass from the 1:1 world into very small scale world would not notice the difference also infront of other fenomonas like speed of sounds, radiations speeds, a question by itself I thouth about, what are the speeds of different radiations etc. if those assumption are wrong so the speed of light at microcosmos is a lot faster than 300000 kilometers for one second relatavely and also the speed of sounds voices and it would be noticed by reserchers at least if not ordinary people and also relatevaly the speed of light would be as I wrote a lot faster and it shoul go beyond time to the future and or past and not to the destiny of oser like some one who pointed with flash light and the beam would light infront of him the day after or before. and if someone woud shout he should be herd almost immediately a lot of kilometers away or at least at a distance of 340 meters, the speed of voice at air at one second without delay of one second but micro second only for example 1 billion: 1 faster, reletavely, the time the sout would cross the 340 meters.

68. using quantum mechanics and inspiration zones in order to createee minimized universe with opposite physics rules by using minus or plus at the magnetic influence and or frequencies of some kind need to be tested. also theory.

69. using quantum mechanics and inspiration zones and model of galaxy, universe by coordinates at software or mechanic and using strings, super strings and at the model by inspiring identified strings by place and building accurate model and by using pneumatic vacume tubes true those strings, super strings. also gravity waves of pollsars by their trails, black holes, until safe point were it is. Maybe basing on trail of sub particlesof somekind will createee safer trail at space between galaxies if subparticlesof some kind exist at the space and/or building a road made of sub particlesat tube at the model/software can use for traveling to vary far astronomicaly distance. also beyond time and/or dimentions/scenario, galaxies, planets because of extrim speed beyond the speed of light. also basing on reshimo of powers and increasing them by quantum mechanics inspiration zones in order to pass capsule, space sheeps with or without passengers vary far astronomicaly, by like sea waves or autostrade, smooth movement. also like pulling a rope at the face of earth and passing a movement up to the seeling over a log of wood maybe it is possible to cristelize a spacesheep at the end of the universe atonce by basing on those forces at this claim, like gravity waves. also by passing somekind of manipulation to the other side of universe by frequencies or shapes at hyulic state or spacesheeps at hyulic state. different frequencies at different powers will take us to different places at time and dimentions/sscenarios or both.

70. using a.m. and/or, f.m. maybe too, and/or t.v. and/or other long range and or shourt, medium range waves waves in order to createee time loops by basing on the shape of the waves and their curves and making the curves and difference from straight line as time loop for example 4 hours instead of 1 hour. at this spare time it is possible to complete missions and work or to some kind of activity, at past or future, if we use quantum mechanics and inspiration zones based on waves and/or magnetic/electromagnetic influence/waves, or combined methods for createeing the inspiration zones maybe favor way but also basing on waves and at same time using other waves at the area can succside. also magnetic and electromagnetic waves can createe time loops because of the style of movement and pointing to the spaces between the curves and the straight lines and by using a graph we can place ourself as passengers at wanted time as needed on scale time table, graph, on existing fiele and/or one we createee spacialy. also electric field sould be checked for that use if there are stable curves

71. theory: the dark metter is probably the gravity of black holes that can explain the fenomona. the cblack holes has endleed amount of metter, material concetrated at endleed power, ratio, and metter createee gravity at direct ratio.

72. using circle of heavy rocks/stones in order to createee natural time machine and moving at circles inside the circle of rocks aiming at thouths to get to other point at time/dimention depending also tests of number of times needed to move at circles. also possible to use holly names if there is fit kabbalist or spiritual person.
also possible to use holly names if there is fit kabbalist or spiritual person. also using circle of heavy rocks/stones in order to createee natural time machine and moving at circles inside the circle of rocks aiming at thouths to get to other point at time/dimention depending also tests of number of times needed to move at circles. also possible to use holly names if there is fit kabbalist or spiritual person. Moving right at clockwise in order to go probably to the future and counter clockwise, left, in order to go to the past probably or the opposite also up at dimentions scale by circling to the right and down at dimentions scales, in order to move down at that scale. also possible wearing of magnetic clothes, shues in order to increase power and efewctivity.

73. using weight/s made of metal magnetic or non magnetic for example and quantum mechanics and inspiration zones and model at software and or mechanics at the center of model of moon, planet with weaker gravity than earth in order to equalize it to the gravity of earth into 1 G. also the opposite by diluating the center of planet, moon and or by using light material at the center of model in order to weaken strong planet, moon gravity into 1 G. also using this thecnics, methods at space stations, space sheeps, spacialy huge ones. using quantum mechanics and inspiration zones and a model with strong gluss, plastic or other strong see true cover or with shadowing if it is close to sun planet, moon and pumping air with oxygen at concetration needed, decided in order to thicken the atmosphere at make it 1 barr pressure. also the opposite by taking out air from close model covered with gluss, other cover in order to diluate thick atmosphere, or by diluating its model or thicken its figure by needs. also possibility to magnetisize the figure of atmosphere or layers, ingridients of it in order to keep it and prevent it to spread at space. also it is possible to prevent deadly storm like that by magnetizing the atmosphere at an wide area at the model by using a figure of area. also preventing like that a storm at sea by magnetizing an wide sea area. using quantum mechanics and inspirations zones and model at sotware and/or mechanics and a tool with oil/balloon of gas/sweat water, in order to fill wales of oil/gas/water/lakes/equipares of sweat water let say when half empty or at other stage. also beyond time and scenario/dimentions.
using quantum mechanics and inspiration zones and model at software and/or mechanics and figure of dangarus fire and spilling water on it on model and inspiring that operation on real fire by great ratio og 1 billion:1 etc. it can be done from headquarter and or from fire truck, plain also sheep etc. also createeing a figure of forrest at danger and spilling on it water and/or right materials that can delay fire and not cousing damage to enviorment. also beyond time/scenario/dimentions. using quantum mechanics and inspiration and models in order to change the zenith of planet in order to couse sesones winter and summer and less extrim weater by using rings of magnets/magnets shaped like rings at model. Narrowing a wide angle will stable the climate and make it more unify all year. Also beyond time/scenario/dimentions.
using quantum mechanics and inspiration zones and models and air conditioner and/or heating in order to be saved from worse weather/climate by projecting on model and inspiring on areas. Also beyond time/scenario/dimentions.
using quantum mechanics and inspiration zones and models in order to duplicate number of times, certain layeres at atmosphere like heliosphere/ozone etc in order to make planet/moon more fit to life. Also beyond time/scenario/dimentions.

74. using quantum mechanics and inspiration zones and model at software and or mechanics and connecting between two or more planets, moons in order to createee new more comfortable climate and or connecting between different climates on same planet, moon, opposite ones in order to get to an average, combination that will fit to people. for example connecting between Venus and Mars in order to get their climate closer to the typical climate of earth or other combinations including between 3, 4, 5 etc. planets and moons. other example is connecting too dry climate to very wet climate with very high humidity.also beyond time for example 100 sienes years ago. Also between different times and seasons from same counry like Israel.

75. theory: positive ions are radio activee radiation and negative ions are electromagnetic radiation.

76. using quantum mechanics and inspiration zones and a model at software and/or mechanics and falls of magnetic powers and/or electromagnetic powers by using magnets positive and or negative, plus and minus and or electromagnetic transmitors and shoutcuts between points at the models that between them and at the points next to one and other will be the transmitors and magnets. also createeing by using small generators, batteries electric filedes and also small radio and or t.v transmitors and antenas at the models for same use.

77. using the materials that fly and fly eiyes and wings made of in order to createe panels for smartphones and tablets and mobile computers mobile phones etc. in order to gather energy for operating the divices also for spacesheeps with boards to collect energy, vihcles of all kinds with panels boards on roof and/or sides, sheeps with boards, panels, plains, chappers, satelites, also panels on roofs of houses, buildings in order to heat the water for showering etc. with close can of water and pipes between them.

78. using quantum mechanics and inspiration zones and model which ti it we add water with a tool and by that for example we can save the death sea from those big holes swallowers near it that atr treating to ruin the tourist activity there because it is my theory the the dryness couse those swallowers holes 27 and highering the level of water will make it easier problem if any. Also beyond time 20 years ago for example.

79. using the differences between the magnetic/electromagnetic/electric/waves signature of uman bodies/objects/animals in order to focus/lock on them in order to launch them to other place and time/dimention/scenario etc. also by using software showing parabola, jumps at those values, vibrations/heat/temperature differences etc. marking them, locking on them and pushing a botton to launch them. also by diluating the body or also air at same time, same moment and make them appear at other place/room etc. at oval cell or outside. wearing a special suit with magnetic influence/electromagnetic influence/transmitors or without and/or electric filed and/or radio/t.v waves from transmitors combined at wearing or from antenas at the oval cell/room, projectors of those forces.

80. using strong magnetic/electromagnetic influence/luminum in order to reap hole at time and/or dimentions also strong electric filed and/or radio/t.v. waves at concentrated luminum or great blust and/or strong radiation.

81. theory about frequencies: if two frequencies operate one next to the other the se weak one might gather to the strong one and not be effectice.

82. using magnetic media in order to keep information beyond time even do the scenario will change, on disc, pages etc. also laca cover can keep information beyond time.

83. using hyulic diulated passengers, objects riding on neutrino particalas stream in order to travel on time and dimentions/scenarios, because maybe neutrinos work at other dimentions and we can see that by their ability to go true everything. also going like that true solid walls.

84. using quantum mechanics and inspiration zones can couse that one person will hear talking going true quantum mechanics and inspiration zones and some one next to him that there is no inspiration on him wouldn't hear anything.

85. theory: maybe gravity particlesgive the matter, material his main mass or at least significant part of it and explain the missing mass the scientist call the black material between the galaxies but I say that maybe the gravity particlesas I call them are inside the atoms.

86. using satelites with sensors sensitive to: magnetic, electromagnetic, t.v./radio waves and or for electric filedes and also plains, chappers, helicopters, un manned plains etc in order to locate hidden territories, duplicated territories etc. by locating those kind of signals, signitures with using also patters like for example shape of city, state, continent etc.

87. theory: particlesat microcosmos like can be createeed with thechnology, methods described here at this invention are smaller with proportion to the ratio of microcosmos for example the atom can be 1 million times smaller than an atom at regular world, reality but everything is relative and it would look to someone who will check it at laboratory like it is same sizes. theoraticaly it can be the opposite if a bigger scenario was createeed the particleswould be for example 10 times bigger if that was the ratio. the gravity is also reletavely to the size and mass of the microcosmos for example if the ratio is 1:1 million the gravity is 1 million times weaker but would fill the same and normal to people at the microcosmos that are one milimiter size or so. and are not affected like mirilecaly from the regular scenario that there are stored in. there is protection and isolation. maybe there is somekind of frequency of gravitation so that is why there is influence from the gravity of the mass of microcosmos alone and not from the great reletavely gravity of regular scenario that we would expected maybe should be dominant

88. using short cuts at mechanic model and quantum mechanics and inspiration zones, the shortcuts should be matalic magnetic bridge between two points in order to couse fast and smooth pas naturaly. the pass at inspiration zones by launching, cristelizing at far point or close is beyond the speed of light. not only by using this method but all pass at quantum mechanics and inspiration zones, it is done immediately. launching beyond time/sscenarios/dimentions, combined.

89. using quantum mechanics and inspiration zones and compressed air jets at the model, in order to defend against great enemy attack from air or sea or land, combined also. also beyond time/scenario/dimention combined.

90. theory also invention: the tohu vavohu, caos before createeion was anti matter, anti material. the situation can pass from metter to anti matter by using quantum mechanics and inspiration zones and new world is a change in that and it takes no time to pass this stage or minus time because if there is no matter, material there is no meaning to time because they connected and depend ideas, culms. distruction getting old of material, matter couse with time passess. Also, sound waves pass easier true and with thick perticals material that's why sound is faster true metal less true water less true air less true diluated aie and not at all at vaccum, space. Mass createee gravity and there is an other connewction possible between gravity and sounds, as the gravity higher the sounds are louder

91. using clothes that protect against certain frequencies on our people and at general and can change to other protection against other frequencies and using frequencies that the enemy is not protected against them and to their area if possible only.

92. Astronomic discovery: every 17th-18th night of the Hebrew mounth the moon looks bigger 20% more sort of, and still fool moon. for example at the 17th night of Tishrey.

93. using parallel launching at the model and the inspiration zone where the passenger is at the time in order to increase power and reach farer at time and dimentions, scenarios etc.

94. theory: maybe there are dimentions for the all universe and not only for every single planet, moon etc or both at the same time. as two or more layers of dimentions one inside the other. as I wrote here maybe mars for example has different dimentions and every planet at our solar system and beyond.

95. using quantum mechanics and inspiration zones and model, at software and/or mechanics in order to place closer a nuclear and/or other reactor, power station to a city in order to not lose energy at the way at cabels for example if a reactor is 110 kilometers from a big city which need energy it is possible to place it 10 kilometers from the city and save a lot of energy from concern of radiation it is possible to keep it far and or place it 200 kilometers instead of 110 kilometers at the model by using the right frequencies of electromagnetic/magnetic, t.v./radio waves,electric filed. Also possibility to duplicate the all power station, reactor etc. by using quantum mechanics and inspiration zones. also beyond time and scenario/dimentions. also increasing power at ratio of for example 1000:1, 100:1, 10:1, 10000:1, 100000:1, 1 milliom:1, 1billion:1, 1 quardilion:1, 1 quardilion*quardilion: 1 etc. with combination of closing the reactor, power station or without.
using quantum mechanics and inspiration zones and model and exact electromagnetic and or magnetic and/or t.v./radio waves and/or electric filed with exact power, frequencies in order to listen and watch sub conscience and conscience, thoughts of people, animals even and by operating electromagnetic filed with enough power those thoughts come up automatically and get to the right person and he or she can see the reaction and talk with them like with hyulic figure.

96. using maneuvering, turn to the left and immediately to the right or the opposite in order to diluated the plain spacesheep and move to other scenario, dimention, time combined usualy to close scenario and maybe by maneuvering several times a lot far. manuvering several times can change the plain into 118. using time machine from present that I invented at this invention and traveling at time to past for example 1 year or 10 year and taking the knowledge to the past and building it at past with equipment that exist at given time with help of people the passenger will connect alone or from his organization and also doing it again if there is no range, several times.
anti metter, anti material. also possible to do the same with vihcle like car, truck, bike etc.

97. theory: the viruses and germs and particlesfor example atom, electron etc. are smaller at microcosmos same ratio as the micro universe of them is smaller for example 1:100 billion. if theoraticaly we createee cosmos bigger than our cosmos the particalas and viruses, germs umans would be bigger. since everything is relative the umans do not fill the difference and belive everything is usual.

98. Using model and quantom mechanics and inspiration zones, pipes and pneumatic pressure in order to launch people wearing astrounts or divers suits and/or usual wearing, between two planets, moons, places dimentions, scenarios, universsess times, past and/or future and combined every possible combination, true the pipes we can launch to points on planets that will be represented at bigger scale and/or launch equipment minimized or not. also at software we can use higher dragging power using electric current and/or hardness or easy ness, objection of stick, operating stick maybe right pixels in addition and transfer people and/or equipment to very far places, also can be called computerized model with managing software operating stick, keyboard, mouse and representing figures for places and people, equipment etc. also true warmholes, stargetes, getting closer two far places by doing it on software, model, posisioning figure of person, equipment like at chess at other planet for example. the inspiration zones connect between the model and real places, for conviniance one building, room can be half planet and/or certien coordinate on other planet by adjusting the inspiration zones.

99. Using warming of the magnets at small or high scale in order to move faster between two points, by rapiding the gravity particles that I thouth about them ans invented the term for it.

100. Using strings between two points at model with inspiration zones, quantum mechanics like strings of laundry with weels that connected at 360 degrees, attaching figures of people and minimized equipment on them with tabs or ties with extra strings.

101. using quantum mechanics and inspiration zone and model build as stick with magnetic metal, iron for example running on it and/or mix with solid stick horazenanly and running part on it and by inspiring on the sticks and running parts and model of earth and solar system with connecting inspiration between them and maybe by using circular stick around model of earth than by running the wait, the running part we can move time or move at time at smaller scale by running around earth and lager scale by moving on track with wait, running part around solar system and so on, around galaxsy, universe models. also using pneumatic pipe around models of earth and solar system and so on with separating parts that's can be removed by pushing a buttom and/or pulling them back and returning tham to position when needed in order to createee barrier in order to createee time zones and anbeling to connect them. also createeing time zones by using rings made of un magnetic or negative magnetic influence with rings in order to createee time zones and by removing the rings, connecting them. at pneumatic system it can be used suction divice for example similar to vacum cleaner.
using quantum mechanics and inspiration zones and the model specialy software but also mechanics and createeing increased dragging force on screen towards the future, for example 1.5, 10.5 years year ahead and on mechanic model createeing a path of magnetic force, influence towards the path of earth for example around the sun 0.5 year, 0.9 year or 11 mounts year ahead towards the points were earth suppose to be by astronomical culculation that computer can do with right existing software. also need to calculate the spin around the galaxy of all solar system.
Using also electromagnetic path by using slive with transmitors on it pointed to right place on mechanic model. also electric field towards the wanted place on future by using slive also ans pneomatich pipe towards wanted point on future. using transmitors transmiting also radio/t.v waves on slive toward the wanted point on time.
using quantum mechanics and inspiration zones and model and micro cosmos in order to build a future, path towards the future using less effort based on former claim, 147, by continuing the magnetic/electromagnetic/electric field/radio/t.v. waves. using t.v/radio waves in order to broadcast the future, createeing it. gathering data from past and present and processing it and transmiting it also with combining other methods for example magnetic inspiration/electromagnetic etc. on strip ahead, luminum. preferd method. inspiration of the present as shelf towards the future based on past and present and natural divelopments and the imagination to our scenario the regular scenario and by that expecting predicting the future even for long period of time. using the slive method and increased dragging force also createeing microcosmos at past and absorbing, watching it carefuly in order to learn the developments of our future at high predictability and also multy scenario check in order to increase chance to be correct. for example 20-100 sscenarios. depend on how many people can work on it.
using quantum mechanics and inspiration zones and the model at software and/or mechanics and clock with strong inspiration and by focusing on the clock and/or time particles, a term I thouth about first and wrote about at this invention. with collective subconsence or camera with strong inspiration maybe it is possible to stop time from running and even run it back or be able to move/glide at time without somekind of cabeles. I noticed that if I focus on the clock it sometimes slowing, the seconds arm at least can show that for short time.
using quantum mechanics and inspiration zones in order to minimize vihcles, cars mainly at parking place at cities without drivers and passengers and return the vihcles at normal size after end of parking, 1 hour, 2 houres, 8 houres, as needed etc. this would save 99.99% of place needed for parking in new York for example or tel aviv. The vihcles will be launched minimized into parking places.
using at and quantum mechanics and inspiration zones and model with tubes with internal cover of diamonds, cristal or hard rocks in order to speed or maybe slow down signifitely and to other point on time than without the diamond cover, cristal, hard rock cover the traveling and get much more far or maybe close. also using other internal cover fmade of polimer or plastic in order to sublimize the affect of other materrtials for example diamonds. using machine for example plain, vihcle, car that can vibrate very fast also possible by adding hypnotic influence or just vibrating floor, stand or divce that hold the passenger safe and hypnotic influence for example pass on time to scenario 10 one week back on tine.

102. using the layers of atmosphere of earth in order to move spacesheeps, special plains on heigths of atmosphere in coordinate to theie caricture, magnetosphere will give magnetic power, inspiration to magnetic based spacesheeps by createeing quantum mechanics inspiration zones and reversing the magnetic power of magnetosphere and lifting the spacesheeps and giving the power to fly fast. thats by using magnets with different angeles or frequencies that will reverse the direction, polls a, radiosphere will give inspiration, of quantum mechanics to radio waves based spacesheeps and wind surf kind motivate by sun particles from heliosphere will move solar charged engines for space sheeps. the right radio frequencies/frequencies can fly spacesheeps. also possibility to move at time and scenario/dimentions. the radio based spacesheeps will carry radio reciver/treansmitor. see drowing s: 9, 10.

103. using ultra perpel, violet waves, and/or m.r.i/c.t scanner in order to scan an object/people and print a copy at other place, 3D, it is possible to diluate the scanned object/people before or not. the magnetic influence and ultra perpel, violet waves probably can createee inspiration zones and work beyond time. using a mobile scanner in order to scan an object/people into the scanner and carry them untyl they will be printed at other place or time or both, that's from diluated state. Using m.r.i scanner in order to make someone, something into magnetic signature and print it when and where needed also beyond time. createeing computerized copy og object/people by using those methods. an magnetic signature of person or object can be passed to other inspiration zone at other time and scenario, carriesd by other person or launching divice and a divice that will get it at other time and place, dimention and will change it to person, object, a copy or adjusted copy with needed changes to mission.

104. using a truck, viacle that carry magnet, electromagnetic transmitor/recivere, generator radio/t.v transmitor/recivere and createeing a path at filed to other place/time/dimention/scenario by building a corridor with right frequencies and createeing a break at dimention and time to the same physical place or other place also by using second vihcle at other wanted place/time if needed as option. by y also as option createeing inspiration zones.

105. using xenon light on passenger or plain, car etc. or exposed and tryning to find break at dimention and pass on time and scenario.
using combination between vibration and xenon light with vihcle or without in order to pass on time and scenario, dimentions. Also using spinning of divice, chair with xenon light or other halogen unicke, halogenic lights with changing and/or fixed intervals, need tests experiments in order to pass on time and dimentions, scenarios and combined on passenger in order to increase efficiency. Also with combination of vibrations of divice, chair.

106. using time machines from this invention in order to drive on time vaccines and medications specialy in order to treat plages, pandemia, epidemia and keeping the rights of the original inventor including myne by the patent authorities and relevant courts. for example at the corona virus pandemia diving the vaccines that will be usefull at 1 year 18 months back at time. also the same for every needed technology.

107. using the time machines in order to pass on time the time treaveling thechnology for example 10 years and again and again by building the machines again 10 years ago with trained passengers who know how to build machines ans so on.

108. using a.m waves and other long range waves in order to createe time loops, also t.v. waves that are long range waves. the curve createee spear time for example instead of 1 hour 4 houres or more. also ability to work at past time at those curves. also using electronic coil with slalom shape in order to createee, by using waves frequencies long time loops by using also quantum mechanics and inspiration zones at different methods: electromagnetic, magnetic, electric, electric field, t.v./radio waves for example a.m by using the special shape of coil also in order to createee curve, loops.

109. using time macines in order to save people who drawuned or were forgaten at closed vihcles beyond time befor they died or damaged by rescuing them or warning them or their parents. also

110. using time machines in order to pass files with information 1 day. 1 week, 1 mounth 1 year, 2 year, 3 year etc. befor beyond time into fixed round times and n sending at email, text massage etc., phone call etc. as service to clients important authorized information in order to save the clients from disaster or un wanted cases and getting paid paid mail, massage from fire and other disasters.

111. using unick frequanciy to each day or hour and/or year in order to get to talk easily with someone at other time and place by adjusting to certien electromagnetic/magnetic signature. the limitation is the number of exsisting frequencies. also by using frequencies scanner with able to lock on certien frequency.

112. remark: this claim was sent to the patent authority office on Jan. 3, 2020 as claim 141 allone from resone I do not remember.using quantum mechanics and inspiration zones and the model at software and/or mechanics in order to heat the figure of a virus/sess and depress it signifecatly. also beyond time and scenario/dimention also injecting new unmeliciuse/unaffective rna to the body in order to change the virus to unmeliciuse/unaffective one also beyond time/scenario if needed and also making it unable to multiply itself fast or at all. Also at germs, funges maybe. doing it on the model should affect the all kind at certain close body of patient/s. it can be used double model in order to affect the all state, city, hospital etc. one after the other, one next to the other. also injecting into patient body directly unmeliciuse rna ans/or unmeliciuse more dominant between virussess type that will fight on same resorssess. beyond time heating for example the figure of virus/germ can save from a plague.

113. theory at physics and gravitation: a: there is a question why dose the planets at our solar system and probably other solar systems are circling aroud the sun at one plato the epliptic and not some platos or at accasion orbits and my answer is that the sun is ball shape and at the center it widest and has the biggest mass and because of that highest gravitation at that joint, circle and the planets get in order by the strongest force at same plato of strongest force. The planets attract to the strongest force. the moon was considered to orbit earth at circle orbit round orbit and not eliptic because I assume its spead is to slow to couse eliptic orbit and dose not has enoght enertion to couse eliptic/oval orbit way, not as earth that circling the sun at spead of 30 kilometers an hour and can band the orbit because of enertion forces.
B: at the level of atom it is the same principal and the electrons and neutrons get in order and orbiting around the proton at the plato with strongest gravitation, level infront of center of proton. the electrons attract to the strongest force.
C: there can be more than one universe at reality because there can be maybe other great blusts at distance of billions of years at astronomical far points at space and they will never meat or only after billions of years they will mix together partly atleast some of them. The distance should be dosents or houndreds, or billions of light years between the different great blusts. the different great blusts might happened at different times because of different reasons, couses. the differences of times can be huge even many billions of years. Other explanation is the micro universe that can be createeed by quantum mechanics and inspiration zones and can be considered as other universes and together as multy universe. also combined.

114. using quantum mechanics and inspiration zones and hypnotic influence in order to couse someone to pass to other time and place, other place, dimention, scenario by imagening himself getting their on thoughts and hypnotic massages to increase his reshimo and magnetic/electromagnetic/electric field reshimo at destiny and cristelize there safely. also it is possible to increase the reshiimo and magnetic/electro magnetic electric field reshimo/signature by machine and parallel power of those by increasing inspiration safely. also blocking with using hypnotic influence massages unwanted, unauthorized people fron traveling beyond time and place or increasing the ability of authorized people.
Also using radio/t.v. waves in order to increase/decrease reshimo/magnetic/electro magnetic signature of passengers at time ans place/dimentions/sscenarios and also using hypnotic massages to couse passengers to belive that they are aimed on certain radio/t.v. frequanciy and increasing their reshimo magnetic/electromagnetic signature or electric field or decreasing it.
using quantum mechanics and inspiration zones in order to multiply T cells and inject them into body in order to treat and immune infront corona illness, covid 19, sars etc. and/or cancer, lokemia or any viral decissess, germs also. also immune the population beyond time. Using quantum mechanics and inspiration zones and model of earth at software and/or mechanics and inligth on the figure of earth ultra perpel/violet, uv waves uhv waves, light waves in order to depress coronba illness all over the world and also other viral and germ coused by decissess and get over the pandemic. the tlength of use can be 20 minutes or other time even few minutes every several days, weeks etc. in order to have control and avoid damage. the idea came to me from the reasin that some countries with ozone problem, hole at ozone layer above them has very law corona cases at their countries for example new zeland and Australia. bougth of those countries has great hole at ozone layers. Also beyond time, as far as the time machines at this invention can reach, for example back to the beginning of the year 2020 and/or to pandemics centuries ago of poxies and the plague. using quantum mechanics and inspiration zones and model at software and/or mechanics and connecting model of enemy planet to quasar in order to destroy it or imitate quasar activity, imitating pulse of gama rays or other rays true the enemy planet.

115. theory and inventions: A: using quantum mechanics and inspiration zones in order to createee minimized sun over Givon when it is night over Ayalon and rest of middle east, the minimized sun will be 1 kilometer in diometer and at hiegth of 1 kilometer or 10 kilometers.
B: using quantum mechanics and inspiration zones and model mechanics and/or at software in order to split the red sea into 12 paths 300 meters wide each one by createeing 11 barriers at the mechanic model from strong polymeric material sucking the water from the paths drying the paths with using even a fan so the land would be dry, the barriers will be used as a wall that holds the water from covering the paths and also spililing into the water matalic magnetic material at the model and use magnetic influence in order to push the water away from the paths also using opposite magnets in order to push away the magnetc water and arranging a set of magnets back to back at lines all the length of the paths by using magnetic stripes at the mechanic model. Also it is wrriten that at that day all the people of Israel visited the holy temple at Jerusalem at miracle way on the wings of volchars and it can be done by launching them minimized to the temple just infront and all the people can be there like that at same time beyond time when it is build also it is possible to launch them across the suf sea to the other banc but that not the original text of tora. it is wrriten that after the people of Israel visited at Jerusalem god returned them to suf sea banc and that he just wanted to proof then he can make great miricles and that they have to build a story, legacy and fololow his instruction carfully. it can be don beyond time with time machines from this invention.
C: Sdom and Amora could have been destroyed by using quantum mechanics and inspiration zones and minimized sun on them 1 kilometer or 10 kilometers wide that could have been destroy the cities of seaners as god said on them.

116. using quantum mechanics and inspiration zones and model at software and or mechanics, two dimentional instead of tree dimentional in order to slow oldness based on that that time connected to material, metter and with tree dimention, metter, material has stronger signature of metter, material so with only two dimentions metterness, materialness would be saved and the connection will slow time because it connect to meter material. also by using slower than usual clock connected to telomers of people ot thicken the telomers and make them longer at the model at software and mechanics in order to extent life at people. Theory at physics: the particlesat an atom, electrons, neutrons maybe even sub particlesare not coolisian, heat one an other because they reject the rest particleslike opposite magnets they have different frequencies of magnetic influence that couse the to stay away and also different electric signature and they all get attracted to the proton and maybe susome of the sub particlesget attracted to same object and other sub particles at same partical like electron reject the same other partical or proton and opposite forces are operating at same time cousing the atom to keep its structure.
Theory at physics also invention: if there is a certien frequency that couse the universe to spread on and on at the empty space sop maybe there is opposite frequency that can couse the universe to shrink and return to starting point of great blust as very small scale concetrated metter at one point and it can be done on model and quantum mechanics and inspiration zones and model software and/or mechanics by using the right frequency at right volume.

117. using time machines from this invention and time travel in order to pass modernic new cameras to the past le say 30 years-40 years and replace the old cameras at satelites and/or telescopes at space in order to get higher resolution and best information from face of earth and benith and from space.

118. using quantum mechanics and inspiration zones and time machines in order to launch all the people that were killed at the holocaust into israel of 2020 to duplicated Israel or tel-aviv or duplicated universe or the regular area at least to part of them by diluating them inti 0 from 1 there at 1939 and cristilising them from 0 to 1 at Israel of 2020 or 1948, 1958 etc. using quantum mechanics and inspiration zones in order to launch satelites beyond time to past or future were information is needed above certain points, exact. and returning them back to present above comfortable points. also launching a duplicated army from present or future into past to problematic security times in order to help the past army at quait difficult missions.

119. Using quantum mechanics and inspiration zones in order to dig a tunnel at width of even 100 meters for example and length of kilometers by using the model and using the tunnel for another time machine that need tunnel in order to connect between points and/or as shortcut between points in the concerns of physical powers that needed to be at operation and for saving energy and for leverage, leveraging the energy the operator user can arrange and in order to get to very far places and/or times and/or dimentions, scenarios etc. Other use is to close tunnels and dig tunnels for trains and for bunkers. Also at the software with dragging force and increased objection it can be done to createe those tunnels. using quantum mechanics and inspiration zones and the model and/or software with dragging force and moving objection in order to dig very big tunnel, a lot of kilometers at length and houndreds of meters width or more by making hole, tunnel at the model, that will be used for leverage, leveraging the power that is used for launching people and equipment to places beyond time and/or dimentions and second leverage is by covering the inside wall of the tunnels with spinning magnets also as I wrote at my invention 262289.il.2018. and 262189.il.2018. by running inspiration from zone to the next zone, gathering power from meter to meter, kilometer to kilometer by the spinning magnets that will be duplicated section after section, 100 each time, 1 kilometer each time or more and or duplicating them on the model and passing the duplicates magnified to the tunnels and/or at the software by createeing figures one after the other also using tunnel after tunnel including from microcosmos should be considered and having like that great leverage and abeling to reach to the end of the universe also beyond time and dimention at very far star at other time billion years ago at other dimention of his. also using running pulssess of magnetic power at fixed and/or escalating power.

120. using moving prizma, prizm at circles and or line and or plain, spacesheep, space stations, satellite and projecting lights true prizma and by riding on the different lights moving at time and scensrios, dimentions parallel gor some passemgers to different destinies, the speed of the carussel, vihcle and the speed of light together will move the amorphous passengers beyond time and dimentions riding on different lights so it is also scensrio/dimentions and time machine. also sending massages to different scenarios, dimentions times with that machine combines with fotons, encrepted also, phone communications data, mobile phone data, internet, t.v. radio waves also. the lights will be projected at the direction of movement. also riding with amorphous vihcles that will be separate from the main vihcle at amorphous state and suits that will give defence or without.
Also using moving prizma, prizm at circles and or line and or plain, spacesheep, space stations, satellite and projecting lights true prizma and by riding on the different lights moving at time and scensrios, dimentions parallel gor some passemgers to different destinies, the speed of the carussel, vihcle and the speed of light together will move the amorphous passengers beyond time and dimentions riding on different lights so it is also scensrio/dimentions and time machine. also sending massages to different scenarios, dimentions times with that machine combines with fotons, encrepted also, phone communications data, mobile phone data, internet, t.v. radio waves also. the lights will be projected at the direction of movement. also riding with amorphous vihcles that will be separate from the main vihcle at amorphous state and suits that will give defence or without.

121. using quantum mechanics and inspiration zones in order to make enemy tunnels collapse like tunnels of terrorists near borders by using magnetic, electromagnetic forces, electric fildes, radio/television waves etc. By putting high weigth on them, on top of tunnels and or filling them at model we prepared with connections. also beyond time if something alreadty happened like terrorist attack. using quantum mechanics and inspiration zones and the model at software and/or mechanics in order to renew the emunition, missiels at plains of air force and sheeps, submarines and other forces including fuel and oils and replacing parts that need replacement on air by replacing them on the model 1:1, or uploading them. also replacing pilots while flying and also duplicating them when there is shortage or as backup. it is possible to do those operation also at automatic flight mode. Using quantum mechanics and inspiration zones in order to duplicate for the pilots a brother, sister parents, friends etc. that will live at other area from the original families.

122. using magnetic power and/or pneumatic power and/or vaccum tunnels for elevators in order to have very fast elevators at buildings and/or bunkers, the magnetic power will act at sides and down and/or up sides in order to tract the elevator to the wanted direction also running magnet, separate from elevator down and up and using it by need up for up and down for down when the extra magnets running on pipes and possible use of several magnets like that in order to have closer magnet to bottom of elevator and its top. at pneumatic the stopping can be by using springs and/or hydraulic mechanisem and/or magnets. also adding the elevators beyond time to bunkers and/or buildings.
*All the rights reserved to: menni menashe zinger. i.d: 027213321. Tel: 0522274294. Address of inventor: menahem begin 31/8 street (Ave.), Ashkelon, Israel .7842187
